(19) United States
(12) Patent Application Publication
(10) Pub. No.: US 2022/0121245 A1
(43) Pub. Date: Apr. 21, 2022

(54) HINGE STRUCTURE FOR FLEXIBLE DISPLAY AND FOLDABLE ELECTRONIC DEVICE

(71) Applicant: Acer Incorporated, New Taipei City (TW)

(72) Inventors: Yi-Ta Huang, New Taipei City (TW); Wu-Chen Lee, New Taipei City (TW); Cheng-Nan Ling, New Taipei City (TW); Wen-Chieh Tai, New Taipei City (TW)

(73) Assignee: Acer Incorporated, New Taipei City (TW)

(21) Appl. No.: 17/356,502

(22) Filed: Jun. 23, 2021

(30) Foreign Application Priority Data
Oct. 20, 2020 (TW) 109136244

(51) Int. Cl. G06F 1/16

(52) U.S. Cl. CPC G06F 1/1681; G06F 1/1652; G06F 1/1616

(57) ABSTRACT

A hinge structure for a flexible display including first, second, third, and fourth rotating shafts, first and second brackets, and first, second, third, and fourth linking members is provided. The first, second, third, and fourth rotating shafts are parallel to each other and kept at a fixed relative distance with each other. The first linking member is pivotally connected to the third and first brackets. The second linking member is pivotally connected to the fourth and second brackets. The third linking member is pivotally connected to the first bracket and connected to the first rotating shaft, and the fourth linking member is pivotally connected to the second bracket and connected to the second rotating shaft. When the first and second rotating shafts pivotally rotate relative to each other, the first and second brackets move close to or away from each other. A foldable electronic device is also provided.

### CROSS-REFERENCE TO RELATED APPLICATION

This application claims the priority benefit of Taiwanese application serial no. 109136244, filed on Oct. 20, 2020. The entirety of the above-mentioned patent application is hereby incorporated by reference herein and made a part of this specification.

### BACKGROUND

### Technical Field

The disclosure relates to a hinge structure; particularly, the disclosure relates to a hinge structure for a flexible display and a foldable electronic device.

### Description of Related Art

As science and technology constantly advance, foldable electronic devices employing a flexible display have gradually become the future development trend. In these devices, such as a smart phone or a notebook computer, a flexible screen is usually disposed on two bodies, so that the flexible display can be switched between a bending state and an unfolded, flattened state as the two bodies rotate to be folded or unfolded relative to each other through a rotating shaft.

However, when the flexible display is bent, changes in the perimeters of the inner and outer sides are present at the bending part. Therefore, when designing a mechanism of the rotating shaft, those changes are required to be taken into consideration and it is required that the mechanism of the rotating shaft is adapted for the above-mentioned bending, to thereby avoid that the rotating shaft is not adapted for the flexible display in respective bending states, which may further cause damage to the flexible display.

### SUMMARY

The disclosure provides a hinge structure for a flexible display and a foldable electronic device, which provide a corresponding pivotal rotation through a linkage mechanism, and provide space for accommodating bending of the flexible display.

The hinge structure of the disclosure is applicable to a flexible display. The hinge structure includes a first rotating shaft, a second rotating shaft, a third rotating shaft, a fourth rotating shaft, a first bracket, a second bracket, a first linking member, a second linking member, a third linking member, and a fourth linking member. The first rotating shaft, the second rotating shaft, the third rotating shaft, and the fourth rotating shaft are parallel to each other and kept at a fixed relative distance with each other. The first linking member is pivotally connected to the third rotating shaft and pivotally connected to the first bracket, the second linking member is pivotally connected to the fourth rotating shaft and pivotally connected to the second bracket, the third linking member is pivotally connected to the first bracket and connected to the first rotating shaft, and the fourth linking member is pivotally connected to the second bracket and connected to the second rotating shaft. When the first rotating shaft and the second rotating shaft pivotally rotate relative to each other, the first bracket and the second bracket move close to or away from each other.

The foldable electronic device of the disclosure includes a first body, a second body, a hinge structure, and a flexible display. The hinge structure is connected between the first body and the second body. The hinge structure includes a first rotating shaft, a second rotating shaft, a third rotating shaft, a fourth rotating shaft, a first bracket, a second bracket, a first linking member, a second linking member, a third linking member, and a fourth linking member. The first rotating shaft, the second rotating shaft, the third rotating shaft, and the fourth rotating shaft are parallel to each other and kept at a fixed relative distance with each other. The first linking member is pivotally connected to the third rotating shaft and pivotally connected to the first bracket, the second linking member is pivotally connected to the fourth rotating shaft and pivotally connected to the second bracket, the third linking member is pivotally connected to the first bracket and connected to the first rotating shaft, and the fourth linking member is pivotally connected to the second bracket and connected to the second rotating shaft. The flexible display is disposed on the first body and the second body and located on the hinge structure. The first body and the second body are pivotally unfolded or closed relative to each other through the hinge structure, and during the pivotally unfolding or closing process, the first bracket and the second bracket move close to or away from each other. In the pivotally unfolding process, the first bracket and the second bracket move close to each other and the flexible display is flattened. In the pivotally closing process, the first bracket and the second bracket move away from each other and bend the flexible display. In addition, bending of the flexible display is accommodated in a space formed after the first bracket and the second bracket move away from each other.

Based on the foregoing, the hinge structure for a flexible display and the foldable electronic device provide a corresponding pivotal rotation through a linkage mechanism, and provide space for accommodating the bending of the flexible display.

Furthermore, the hinge structure includes the four rotating shafts that are parallel to each other and kept at a fixed relative distance with each other. In addition, with two of them as bases and in combination with the corresponding linking member, the rotating shafts respectively form a first linking rod set and a second linking rod set corresponding to each other. Accordingly, during the pivotal rotation of the two linking rod sets, a state of the first bracket and the second bracket moving close to or away from each other is generated to correspond to the required accommodating space for the flexible display when switching between the flattened and bending states.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram of a foldable electronic device according to an embodiment of the disclosure.

FIG. 1B is a schematic diagram of a hinge structure of the foldable electronic device as shown in FIG. 1A.

FIG. 2 is an exploded view of the hinge structure as shown in FIG. 1B.

FIG. 3A to FIG. 3C are schematic diagrams illustrating the hinge structure as shown in FIG. 1B in different states from a cross-sectional perspective.

FIG. 4 is a partial side view of the hinge structure as shown in FIG. 1B.

### DESCRIPTION OF THE EMBODIMENTS

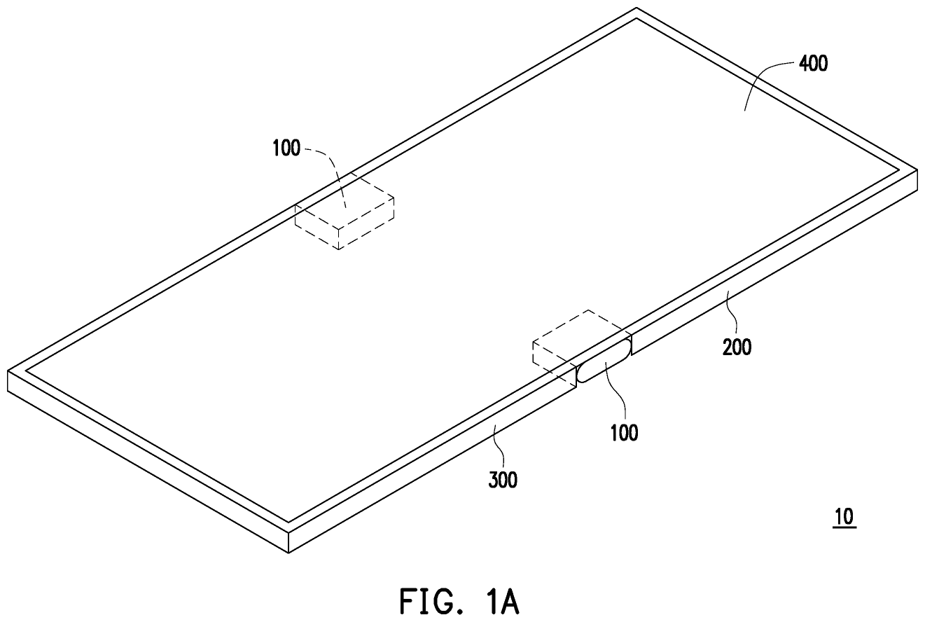

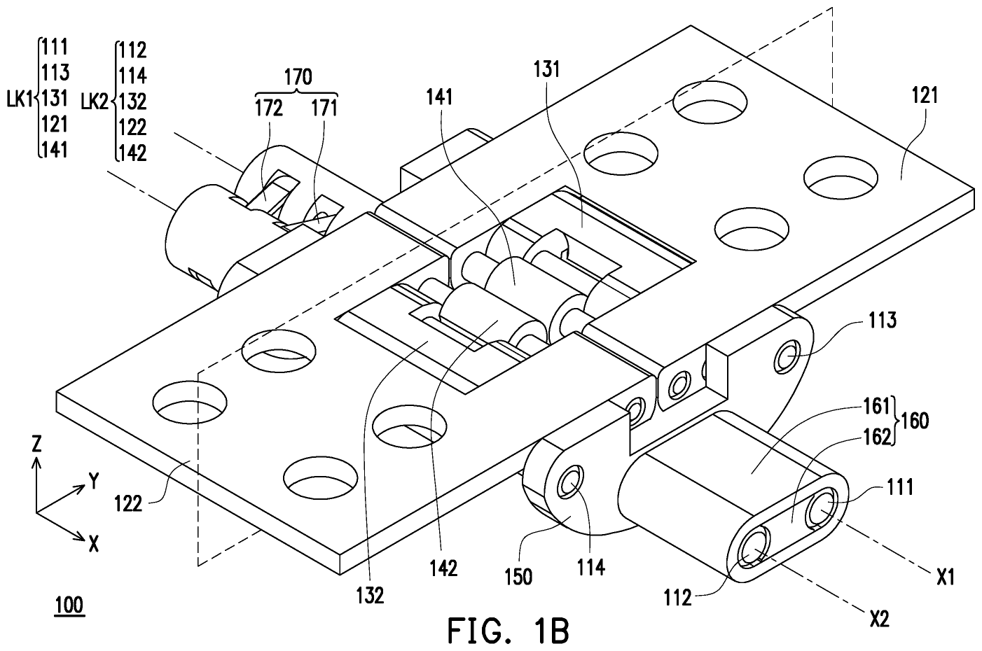

FIG. 1A is a schematic diagram of a foldable electronic device according to an embodiment of the disclosure. FIG. 1B is a schematic diagram of a hinge structure of the foldable electronic device as shown in FIG. 1A. Herein a Cartesian coordinate system X-Y-Z is provided for facilitation of the description of components. With reference to FIG. 1A and FIG. 1B at the same time, in this embodiment, a foldable electronic device 10 includes a first body 200, a second body 300, a hinge structure 100, and a flexible display 400. The hinge structure 100 is connected between the first body 200 and the second body 300. The hinge structure 100 includes a first rotating shaft 111, a second rotating shaft 112, a third rotating shaft 113, a fourth rotating shaft 114, a first bracket 121, a second bracket 122, a first linking member 131, a second linking member 132, a third linking member 141, and a fourth linking member 142. The first rotating shaft 111, the second rotating shaft 112, the third rotating shaft 113, and the fourth rotating shaft 114 are parallel to each other and kept at a fixed relative distance with each other. The flexible display 400 is disposed on the first body 200 and the second body 300 and is located on the hinge structure 100. The first body 200 and the second body 300 are pivotally unfolded or closed relative to each other through the hinge structure 100. Herein, a pivotally unfolded state of the foldable electronic device 10 is as shown in FIG. 1A, and the flexible display 400 is in a flattened state at this time.

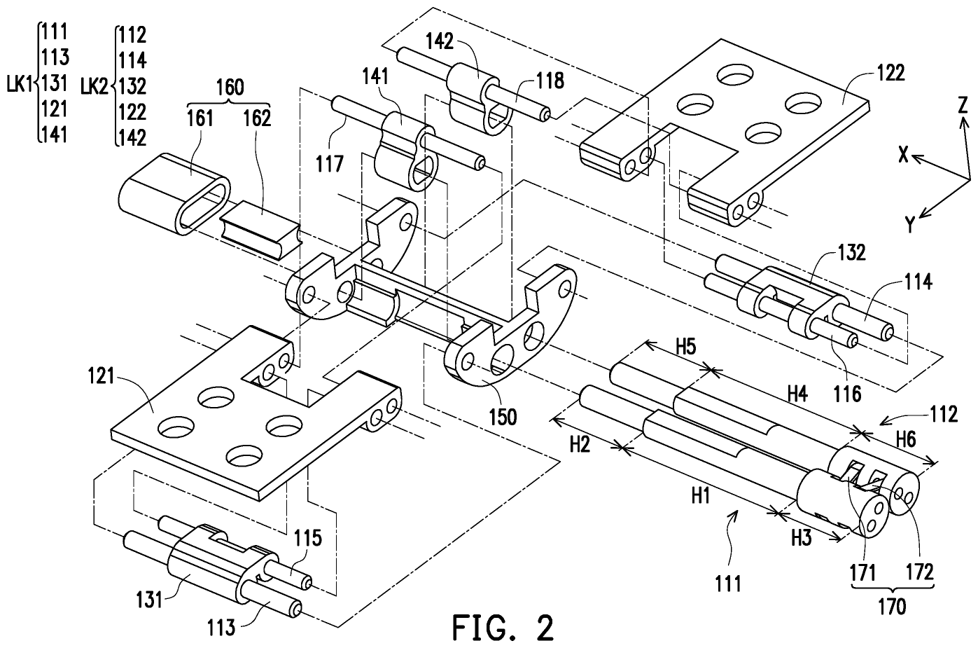

FIG. 2 is an exploded view of the hinge structure as shown in FIG. 1B. With reference to FIG. 1B and FIG. 2 at the same time, in this embodiment, the first linking member 131 is pivotally connected to the third rotating shaft 113 and pivotally connected to the first bracket 121, the second linking member 132 is pivotally connected to the fourth rotating shaft 114 and pivotally connected to the second bracket 122, the third linking member 141 is pivotally connected to the first bracket 121 and connected to the first rotating shaft 111, the fourth linking member 142 is pivotally connected to the second bracket 122 and connected to the second rotating shaft 112. Furthermore, as shown in FIG. 2, the hinge structure 100 also includes a plurality of pivotal shafts 115-118. Herein, the first linking member 131 is pivotally connected to the first bracket 121 by the pivotal shaft 115, the second linking member 132 is pivotally connected to the second bracket 122 by the pivotal shaft 116, the third linking member 141 is pivotally connected to the first bracket 121 by the pivotal shaft 117, and the fourth linking member 142 is pivotally connected to the second bracket 122 by the pivotal shaft 118.

To be specific, with reference to FIG. 2 again, where the third linking member 141 is fixed to and rotates synchronously with the first rotating shaft 111, and the fourth linking member 142 is fixed to and rotates synchronously with the second rotating shaft 112. As shown in FIG. 2, since a shaft body having a flat surface of the first rotating shaft 111 and the second rotating shaft 112 corresponds to an opening having a flat surface of the third linking member 141 and the fourth linking member 142, the corresponding members can pivotally rotate along the X axis smoothly. Herein, the first rotating shaft 111 has a central axis X1, and the second rotating shaft 112 has a central axis X2.

Moreover, the hinge structure 100 also includes a fixing frame 150, which substantially exhibits an “I” shape and has a central structure and two separators connected to two opposite ends of the central structure along the X axis. The first rotating shaft 111, the second rotating shaft 112, the third rotating shaft 113, and the fourth rotating shaft 114 are respectively disposed through four fixed positions of the fixing frame 150 to achieve the above-mentioned state of being parallel to each other and kept at a fixed relative distance with each other. Herein, the first rotating shaft 111, the third rotating shaft 113, the first linking member 131, the first bracket 121, and the third linking member 141 are located on one side of the fixing frame 150, and the second rotating shaft 112, the fourth rotating shaft 114, the second linking member 132, the second bracket 122, and the fourth linking member 142 are located on the other side of the fixing frame 150, and are spaced apart by the central structure of the fixing frame 150 from the former group of members (the first rotating shaft 111, the third rotating shaft 113, the first linking member 131, the first bracket 121, and the third linking member 141) and are opposite thereto.

Herein, the first rotating shaft 111 extends along the X axis and is divided into segments H1, H2, and H3. The segment H1 is connected between the segment H2 and the segment H3. Thereby, when being disposed through the fixing member 150, the segment H1 is adjacent to the central structure and located between the two separators, the segments H1 and H2 are spaced apart by one of the separators and are opposite to each other, and the segments H1 and H3 are spaced apart by the other separator and are opposite to each other. Similarly, the second rotating shaft 112 extends along the X-axis and is divided into segments H4, H5, and H6. The configuration thereof is the same as the first rotating shaft 111, and will not be repeatedly described herein.

Besides, the hinge structure 100 also includes a linkage assembly 170 and a torque assembly 160. The linkage assembly 170 is connected between the first rotating shaft 111 and the second rotating shaft 112 to synchronously rotate the first rotating shaft 111 and the second rotating shaft 112, of which further description will follow. The torque assembly 160 is connected between the first rotating shaft 111 and the second rotating shaft 112. In addition, the torque assembly 160 and the linkage assembly 170 are located on two opposite ends of the first rotating shaft 111 and the second rotating shaft 112 along the X axis. As shown in FIG. 2, the linkage assembly 170 is disposed on the segments H3 and H6 of the first rotating shaft 111 and the second rotating shaft 112, and the torque assembly 160 is disposed on the segments H2 and H5 of the first rotating shaft 111 and the second rotating shaft 112. Herein, the torque assembly 160 includes a limiting sleeve 161 and a limiting block 162, where the limiting sleeve 161 is sleeved on the limiting block 162. The segments H2 and H5 of the first rotating shaft 111 and the second rotating shaft 112, being clamped and abutted, are limited between the limiting sleeve 161 and the limiting block 162 to accordingly generate a friction force as the torque required during the pivotal rotation of the first rotating shaft 111 and the second rotating shaft 112.

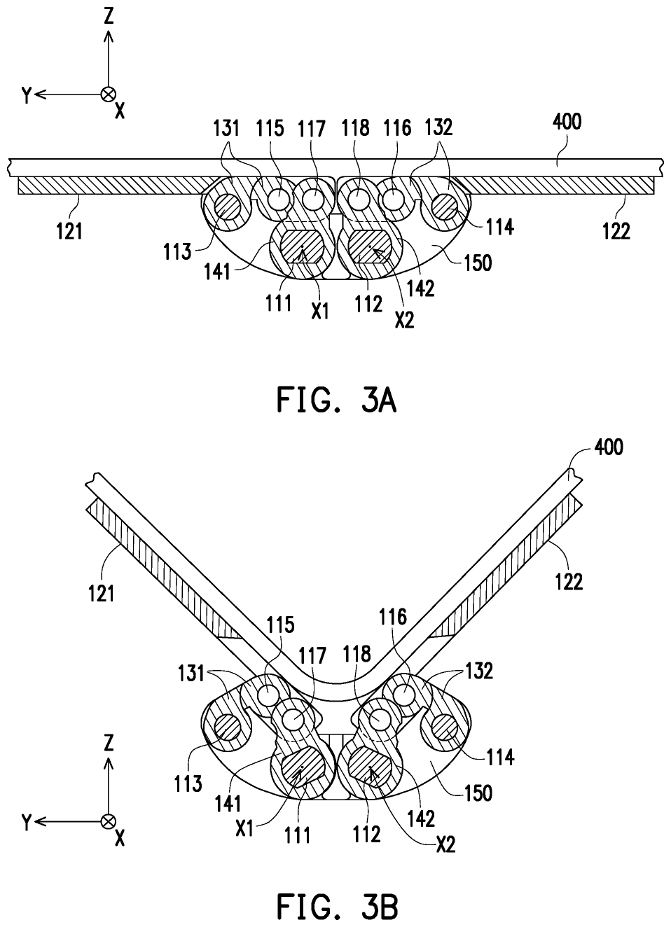

FIG. 3A to FIG. 3C are schematic diagrams illustrating the hinge structure as shown in FIG. 1B in different states from a cross-sectional perspective. With reference to FIG. 1B, FIG. 2, and FIG. 3A, through the pivotal connection or connection relationship of the above-mentioned components, the first rotating shaft 111, the third rotating shaft 113, the first linking member 131, the first bracket 121, and the third linking member 141 form a first linking rod set LK1, and the second rotating shaft 112, the fourth rotating shaft 114, the second linking member 132, the second bracket 122, and the fourth linking member 142 form a second linking rod set LK2. Through the first linking rod set LK1 and the second linking rod set LK2, the hinge structure 100 completes the required pivotal rotation.

With reference to FIG. 3A to FIG. 3C at the same time, a process shown by which is namely the hinge structure 100 gradually switching from the unfolded state to a closed (folded) state, and is also corresponding to the foldable electronic device 10 switching from the unfolded state shown in FIG. 1 to a state where the first body 200 and the second body 300 are closed (folded) relative to each other. It can be clearly seen from the process as shown from FIG. 3A to FIG. 3C that since the hinge structure 100 forms the first linking rod set LK1 and the second linking rod set LK2 as mechanisms that are mirror-symmetrical with each other, the first bracket 121 and the second bracket 122 will gradually move away during the pivotally closing process shown (in FIG. 3A to FIG. 3C). Moreover, when the flexible display 400 exhibits bending as the first body 200 and the second body 300 are pivotally closed, the bending thus formed can be accommodated in a space (as shown in FIG. 3C) formed when the first bracket 121 and the second bracket 122 move away from each other. On the contrary, with reference to a process as shown from FIG. 3C to FIG. 3A, when the first bracket 121 and the second bracket 122 are pivotally unfolded relative to each other (also equivalent to that the first body 200 and the second body 300 are pivotally unfolded relative to each other), then the first bracket 121 and the second bracket 122 move close to each other until being maintained on a plane (the plane being parallel to the XY plane) as shown in FIG. 3A, so that the flexible display 400 in the flattened state can be smoothly supported.

Besides, with reference to FIG. 2 again, the first linking member 131 and the third linking member 141 are located in a recess of the first bracket 121, and the second linking member 132 and the fourth linking member 142 are located in a recess of the second bracket 122. As shown in FIG. 1B, when the first bracket 121 and the second bracket 122 move close to each other, the recess of the first bracket 121 and the recess of the second bracket 122 form a closed contour, so that the first linking member 131, the third linking member 141, the second linking member 132, and the fourth linking member 142 are located together within the closed contour.

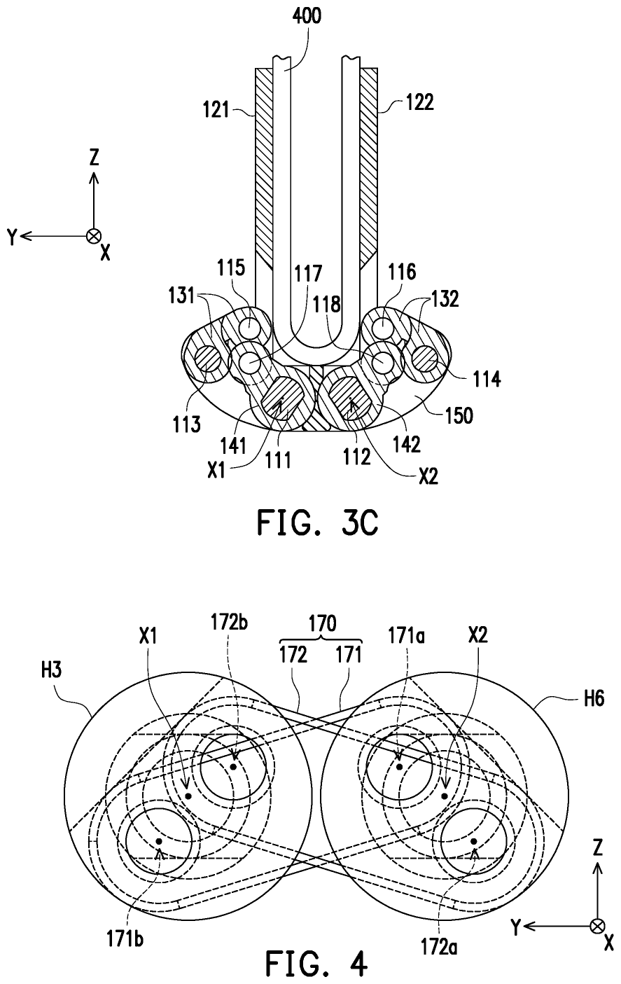

FIG. 4 is a partial side view of the hinge structure as shown in FIG. 1B. With reference to FIGS. 2 and 4 at the same time, in this embodiment, the linkage assembly 170 is pivotally connected to an eccentric position of the first rotating shaft 111 and pivotally connected to an eccentric position of the second rotating shaft 112. In other words, the linkage assembly 170 includes linking rods 171 and 172, and as shown in FIG. 4, respective pivot points 171b and 171a of the linking rod 171 with the first rotating shaft 111 and the second rotating shaft 112 are eccentric to the central axis X1 of the first rotating shaft 111 and are also eccentric to the central axis X2 of the second rotating shaft 112. In addition, respective pivot points 172b and 172a of the linking rod 172 with the first rotating shaft 111 and the second rotating shaft 112 are eccentric to the central axis X1 of the first rotating shaft 111 and are also eccentric to the central axis X2 of the second rotating shaft 112. Moreover, the linkage assembly 170 is also a mechanism that is exhibited as mirror-symmetrical. Therefore, based on the above, through the linkage assembly 170, the first rotating shaft 111 and the second rotating shaft 112 smoothly counter-rotate synchronously.

In summary of the foregoing, in the above-mentioned embodiments of the disclosure, the hinge structure includes the four rotating shafts that are parallel to each other and kept at a fixed relative distance with each other. In addition, with two of them as bases and in combination with the corresponding linking member, the rotating shafts respectively form the first linking rod set and the second linking rod set corresponding to each other. Accordingly, during the pivotal rotation of the two linking rod sets, a state of the first bracket and the second bracket moving close to or away from each other is generated to correspond to the required accommodating space for the flexible display when switching between the flattened and bending states.

In other words, with the above-mentioned first linking rod set and the second linking rod set, the hinge structure is a mechanism that exhibits a mirror-image correspondence. Furthermore, through the linkage assembly, the first rotating shaft and the second rotating shaft synchronously counter-rotate, at the same time the first bracket and the second bracket are also driven to rotate in the same manner, and accordingly the required moving away or close is resulted to smoothly correspond to the shape change of the flexible display in the bending or flattened state. Thereby, the foldable electronic device having the flexible display is pivotally unfolded or closed smoothly without causing damage to the flexible display.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A hinge structure for a flexible display, comprising:
a first rotating shaft, a second rotating shaft, a third rotating shaft, and a fourth rotating shaft parallel to each other and kept at a fixed relative distance with each other;
a first bracket and a second bracket; and
a first linking member, a second linking member, a third linking member, and a fourth linking member, wherein the first linking member is pivotally connected to the third rotating shaft and pivotally connected to the first bracket, the second linking member is pivotally connected to the fourth rotating shaft and pivotally connected to the second bracket, the third linking member is pivotally connected to the first bracket and connected to the first rotating shaft, and the fourth linking member is pivotally connected to the second bracket and connected to the second rotating shaft,
wherein the first rotating shaft, the third rotating shaft, the first linking member, the first bracket, and the third linking member form a first linking rod set, and the second rotating shaft, the fourth rotating shaft, the second linking member, the second bracket, and the fourth linking member form a second linking rod set, such that when the first rotating shaft and the second rotating shaft pivotally rotate relative to each other, the first bracket and the second bracket move close to or away from each other.

2. The hinge structure as described in claim 1, wherein the third linking member is fixed to and rotates synchronously with the first rotating shaft, and the fourth linking member is fixed to and rotates synchronously with the second rotating shaft.

3. The hinge structure as described in claim 1, further comprising a fixing frame, wherein the first rotating shaft, the second rotating shaft, the third rotating shaft, and the fourth rotating shaft are respectively disposed through the fixing frame, the first rotating shaft, the third rotating shaft, the first linking member, the first bracket, and the third linking member are located on one side of the fixing frame, and the second rotating shaft, the fourth rotating shaft, the second linking member, the second bracket, and the fourth linking member are located on the other side of the fixing frame.

4. The hinge structure as described in claim 1, wherein the first linking member and the third linking member are located in a recess of the first bracket, and the second linking member and the fourth linking member are located in a recess of the second bracket, wherein when the first bracket and the second bracket move close to each other, the recess of the first bracket and the recess of the second bracket form a closed contour, and the first linking member, the third linking member, the second linking member, and the fourth linking member are located within the closed contour.

5. The hinge structure as described in claim 1, wherein the first linking rod set and the second linking rod set are mechanisms mirror-symmetrical with each other.

6. The hinge structure as described in claim 1, further comprising a linkage assembly connected between the first rotating shaft and the second rotating shaft to synchronously rotate the first rotating shaft and the second rotating shaft.

7. The hinge structure as described in claim 6, wherein the linkage assembly is pivotally connected to an eccentric position of the first rotating shaft and pivotally connected to an eccentric position of the second rotating shaft.

8. The hinge structure as described in claim 6, further comprising a torque assembly connected between the first rotating shaft and the second rotating shaft, wherein the torque assembly and the linkage assembly are located on two opposite ends of the first rotating shaft and the second rotating shaft.

9. A foldable electronic device, comprising:
a first body;
a second body;
a hinge structure connected between the first body and the second body, wherein the hinge structure comprises:
a first rotating shaft, a second rotating shaft, a third rotating shaft, and a fourth rotating shaft parallel to each other and kept at a fixed relative distance with each other;
a first bracket and a second bracket disposed respectively on the first body and the second body; and
a first linking member, a second linking member, a third linking member, and a fourth linking member, wherein the first linking member is pivotally connected to the third rotating shaft and pivotally connected to the first bracket, the second linking member is pivotally connected to the fourth rotating shaft and pivotally connected to the second bracket, the third linking member is pivotally connected to the first bracket and connected to the first rotating shaft, and the fourth linking member is pivotally connected to the second bracket and connected to the second rotating shaft,
wherein the first rotating shaft, the third rotating shaft, the first linking member, the first bracket, and the third linking member form a first linking rod set, and the second rotating shaft, the fourth rotating shaft, the second linking member, the second bracket, and the fourth linking member form a second linking rod set; and
a flexible display disposed on the first body and the second body and located on the hinge structure,
wherein the first body and the second body are pivotally unfolded or closed relative to each other through the hinge structure, and during the pivotally unfolding or closing process, the first bracket and the second bracket move close to or away from each other, wherein in the pivotally unfolding process, the first bracket and the second bracket move close to each other and the flexible display is flattened, in the pivotally closing process, the first bracket and the second bracket move away from each other and bend the flexible display, and bending of the flexible display is accommodated in a space formed after the first bracket and the second bracket move away from each other.

10. The foldable electronic device as described in claim 9, wherein the third linking member is fixed to and rotates synchronously with the first rotating shaft, and the fourth linking member is fixed to and rotates synchronously with the second rotating shaft.

11. The foldable electronic device as described in claim 9, wherein the hinge structure further comprises a fixing frame, wherein the first rotating shaft, the second rotating shaft, the third rotating shaft, and the fourth rotating shaft are respectively disposed through the fixing frame, the first rotating shaft, the third rotating shaft, the first linking member, the first bracket, and the third linking member are located on one side of the fixing frame, and the second rotating shaft, the fourth rotating shaft, the second linking member, the second bracket, and the fourth linking member are located on the other side of the fixing frame.

12. The foldable electronic device as described in claim 9, wherein the first linking member and the third linking member are located in a recess of the first bracket, and the second linking member and the fourth linking member are located in a recess of the second bracket, wherein when the first bracket and the second bracket move close to each other, the recess of the first bracket and the recess of the second bracket form a closed contour, and the first linking member, the third linking member, the second linking member, and the fourth linking member are located within the closed contour.

13. The foldable electronic device as described in claim 9, wherein the first linking rod set and the second linking rod set are mechanisms mirror-symmetrical with each other.

14. The foldable electronic device as described in claim 9, wherein the hinge structure further comprises a linkage assembly connected between the first rotating shaft and the second rotating shaft to synchronously rotate the first rotating shaft and the second rotating shaft.

15. The foldable electronic device as described in claim 14, wherein the linkage assembly is pivotally connected to an eccentric position of the first rotating shaft and pivotally connected to an eccentric position of the second rotating shaft.

16. The foldable electronic device as described in claim 14, wherein a torque assembly connected between the first rotating shaft and the second rotating shaft, wherein the torque assembly and the linkage assembly are located on two opposite ends of the first rotating shaft and the second rotating shaft.
